(19) United States
(12) Patent Application Publication
(10) Pub. No.: US 2026/0187464 A1
(43) Pub. Date: Jul. 2, 2026

(54) AI MODEL TRAINING METHOD USING ACCUMULATIVE LOSS FUNCTION

(71) Applicant: Korea Electronics Technology Institute, Seongnam-si (KR)

(72) Inventors: Seok Hun JEON, Seongnam-si (KR); Kyeong Mo KIM, Seongnam-si (KR); Byung Soo KIM, Yongin-si (KR); Young Jong JANG, Yongin-si (KR); Yun Pyo HONG, Yongin-si (KR)

(73) Assignee: Korea Electronics Technology Institute, Seongnam-si (KR)

(21) Appl. No.: 19/374,208

(22) Filed: Oct. 30, 2025

(30) Foreign Application Priority Data
Dec. 30, 2024 (KR) 10-2024-0199576

(51) Int. Cl. G06N 3/088; G06N 3/049

(52) U.S. Cl. CPC G06N 3/088; G06N 3/049

(57) ABSTRACT

Provided is an AI model training method using an accumulative loss function. The AI model training method according to an embodiment may input time-series training data into an AI model, may calculate a loss between time-series correct answer data and time-series output data which is outputted from the AI model, and may update parameters of the AI model based on the calculated loss, and may calculate, as the loss, a difference between time-series output cumulative data, which results from time-series accumulation of time-series output data, and time-series cumulative correct answer data, which results from time-series accumulation of time-series correct answer data. Accordingly, by training an AI model using an accumulative loss function which is a customized loss function considering characteristics of event-based data, problems of temporal continuity, sparsity, imbalance of data may be solved.

### CLAIM OF PRIORITY

This application is based on and claims priority under 35 U.S.C. § 119 to Korean Patent Application No. 10-2024-0199576, filed on Dec. 30, 2024, in the Korean Intellectual Property Office, the disclosure of which is herein incorporated by reference in its entirety.

### BACKGROUND

### Field

The disclosure relates to artificial intelligence (AI) model training, and more particularly, to a method for designing a loss function to be used for training an AI model and training the AI model using the same.

### Description of Related Art

Data collected in event cameras only record information on changes occurring along the time axis compared to that of traditional frame cameras. This is characterized by sparsity and continuity of data, and there is a need for AI models of different approaches from traditional frame camera data processing methods and training therefor.

Related-art event data-based AI models are mostly trained by using a frame-based loss function. However, this loss function is suitable for traditional image data comprised of frame units, but does not effectively reflect the sparse event occurrence frequency and the timing difference which are characteristics of event data. This leads the following problems:
Lack of temporal dimension reflection: Event data is information that fluctuates over time, but traditional loss functions do not fully reflect continuity of the time axis, resulting in a problem of loss of temporally important information.
Data sparsity: Since an event only occurs at specific time intervals, AI models may not acquire enough information with traditional loss functions due to the sparsity of data.
Imbalance: Event data has a large variation in the occurrence frequency, so that data of some classes may be significantly less or more than other classes. Such data imbalance may cause an AI model to overfit to a specific class or underperform for a small number of classes.

### SUMMARY

The disclosure has been developed in order to solve the above-described problems, and an object of the disclosure is to provide an AI model training method using an accumulative loss function which is a customized loss function considering characteristics of event data, as a solution to solve problems of temporal continuity, sparsity, imbalance of event-based data generated by an event camera.

According to an embodiment of the disclosure to achieve the above-described object, an AI model training method may include: inputting time-series training data into an AI model; calculating a loss between time-series correct answer data and time-series output data which is outputted from the AI model; and updating parameters of the AI model based on the calculated loss, and calculating may include calculating, as the loss, a difference between time-series output cumulative data, which results from time-series accumulation of time-series output data, and time-series cumulative correct answer data, which results from time-series accumulation of time-series correct answer data.

The AI model may output a plurality of pieces of time-series output data simultaneously, and the correct answer data may be a plurality of pieces of time-series correct answer data, and calculating may include calculating, as the loss, a sum of each difference between each piece of time-series output cumulative data, which results from the time-series accumulation of each piece of time-series output data, and each piece of time-series cumulative correct answer data, which results from the time-series accumulation of each piece of time-series correct answer data.

The plurality of pieces of time-series output data and the plurality of pieces of time-series correct answer data may be data corresponding to a plurality of classes.

The loss may have a positive correlation with a class classification difficulty.

The loss may have a positive correlation with a similarity between the plurality of pieces of time-series output data.

The loss may be normalized to offset an increase in a data size caused by data accumulation.

Calculating may include dividing the time-series output data in the unit of a defined time section and accumulating the time-series output data.

The time-series training data and the time-series correct answer data may be event camera data.

The AI model may be a spiking neural network (SNN) for data classification.

According to another aspect of the disclosure, there is provided an AI model training system including: a processor configured to input time-series training data into an AI model, to calculate a loss between time-series correct answer data and time-series output data which is outputted from the AI model, and to update parameters of the AI model based on the calculated loss; and a storage unit configured to provide a storage space needed for the processor, wherein the processor is configured to calculate, as the loss, a difference between time-series output cumulative data, which results from time-series accumulation of time-series output data, and time-series cumulative correct answer data, which results from time-series accumulation of time-series correct answer data.

According to still another aspect of the disclosure, there is provided an AI model inference method including: acquiring time-series data; and inputting the acquired time-series data into an AI model and performing inference, wherein the AI model is trained to generate a result of inference from time-series input data as time-series output data, and is trained by calculating, as a loss, a difference between time-series output cumulative data, which results from time-series accumulation of time-series output data, and time-series cumulative correct answer data, which results from time-series accumulation of time-series correct answer data.

As described above, according to embodiments of the disclosure, by training an AI model by using an accumulative loss function which is a customized loss function considering characteristics of event-based data generated by an event camera, the following effects may be expected:
Reflecting temporal continuity: Since the accumulative loss function better reflects temporal continuity of event data when training AI models, the AI models may be more effectively trained to learn events at critical points of time, thus preventing a loss of important information along the time axis and improving the performance of the AI models.
Compensating for data sparsity: Data sparsity may be compensated by calculating an accumulative loss for infrequently occurring event data, so that training efficiency is maximized and all event evenly contributes to training.
Solving data imbalance: In the case of event-based data, data imbalance is severe for each class, and, by calculating a large loss for classes that are difficult to classify due to insufficient training with a small number of pieces of data, and calculating a small loss for classes that are easy to classify due to sufficient training with a large number of pieces of data, the training performance for a small number of classes may be relatively more enhanced, and the problem of data imbalance may be alleviated.
Improving training performance: By training AI models using an accumulative loss function, training better reflecting characteristics of event-based data is possible, and as a result, the overall performance of the AI models may be significantly improved.
Applicability: The accumulative loss function may be applied to other types of AI models in addition to AI models for event data processing, opening new horizons for AI model training.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating examples of final output spike values;

FIG. 2 is a view illustrating examples of final output spike values;

FIG. 3 is a view illustrating examples of correct answer spike values;

FIGS. 4A and 4B are views illustrating examples of final output spike cumulative values;

FIGS. 5 A and 5B are views illustrating examples of final output spike cumulative values;

FIGS. 6 A and 6B are views illustrating examples of correct answer spike cumulative values;

FIG. 7 A-7C are views illustrating calculating a loss in the examples of FIGS. 1, 4;

FIG. 8 A-8C are views illustrating calculating a loss in the examples of FIGS. 2, 5;

FIG. 9 is a view illustrating Prophesee Gee4-based label imbalance classification datasets;

FIGS. 10 A and 10B are views illustrating training loss curve and accuracy graphs;

FIG. 11 is a table for comparing precision, recall, F1-score for each class of data for verification;

FIG. 12 is a view illustrating comparison of classification result confusion matrices of test data; and

FIG. 13 is a view illustrating a spiking neural network (SNN) operating system.

### DETAILED DESCRIPTION

Hereinafter, the disclosure will be described in more detail with reference to the accompanying drawings.

Embodiments of the disclosure propose an AI model training method using an accumulative loss function. The disclosure relates to a technique for designing an accumulative loss function to reflect temporal continuity of data and to solve sparsity and imbalance, and training an AI model using the same.

A spiking neural network (SNN) refers to a neural network that is configured with spiking neurons connected with one another, and counts final output spike values (0 or 1) for a predetermined time and uses the result of counting as an inference result.

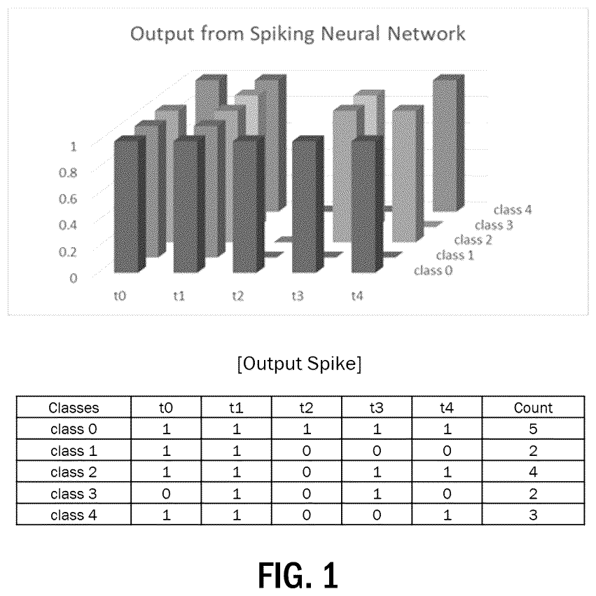

For example, if the SNN which classifies data into 5 classes (class 0 to class 4) outputs final output spike values from t0 to t4 as a result of processing input data as shown in FIG. 1, the input data may be classified into class 0 that has the largest final output spike count value (the sum of the final output spike values).

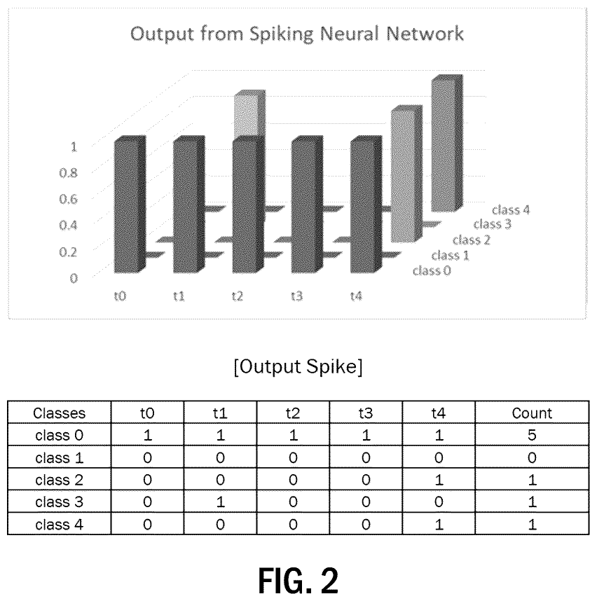

Even if the final output spike values are as shown in FIG. 2, class 0 still has the largest final output spike count value, so that the input data is classified into class 0.

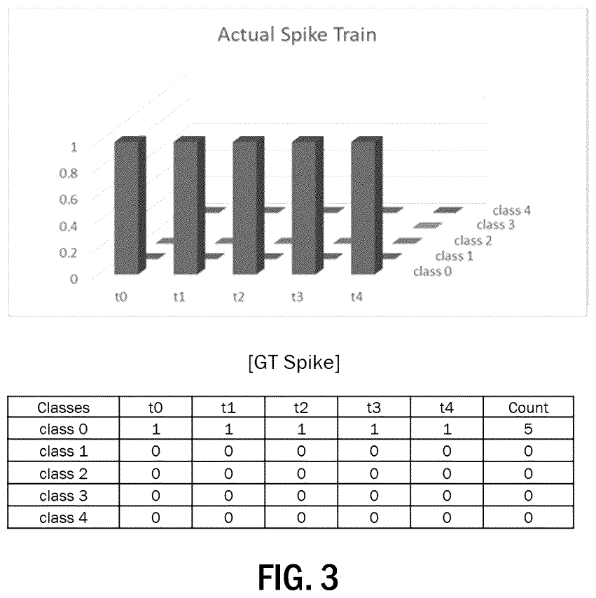

If correct answers of the classification performed in FIGS. 1 and 2, that is, the most ideal final output spike values, are as shown in FIG. 3, the SNN in the example presented in FIGS. 1 and 2 accurately classifies the input data. To train this SNN, a loss function presented in following Equation 1 may be used:

$$L = {\sum }_{n = 0}^{N} {( {\sum }_{t = 0}^{{t}_{k}} d [ t ] - {\sum }_{t = 0}^{{t}_{k}} s [ t ] )}^{2} \qquad Equation 1$$

where d[t] is a final output spike value at a time t,

$${\sum }_{t = 0}^{{t}_{k}} d [ t ]$$

is a final output spike count value from t₀ to tₖ,

$${\sum }_{t = 0}^{{t}_{k}} s [ t ]$$

is a correct answer spike count value (the sum of correct answer spike values) from t₀ to tₖ. In the above example, there are five classes, so that N is 4, and time is t₀-tₖ, so that k is 4.

According to Equation 1 above, the loss (L) is the sum of the squared values of the difference between the final output spike count value and the correct answer spike count value in each class (n).

However, the loss function above does not reflect temporal continuity of the final output spike values, and has the problem of being vulnerable to sparsity of the final output spike value and imbalance of data for each class.

Accordingly, embodiments of the disclosure presents an accumulative loss function that reflects temporal continuity of final output spike values and enables robust training in spite of the sparsity of final output spike values and imbalance of data for each class through following Equation 2:

$$L = {\sum }_{n = 0}^{N} ( {\sum }_{t = 0}^{{t}_{k}} {( {D}_{c} [ t ] - {S}_{c} [ t ] )}^{2} ) \qquad Equation 2$$

$${D}_{c} [ t ] = {\sum }_{i = 1}^{t} d [ i ] , {S}_{c} [ t ] = {\sum }_{i = 1}^{t} s [ i ]$$

where D_{c}[t] is a final output spike cumulative value at time t, and S_{c}[t] is a correct answer spike cumulative value at time t.

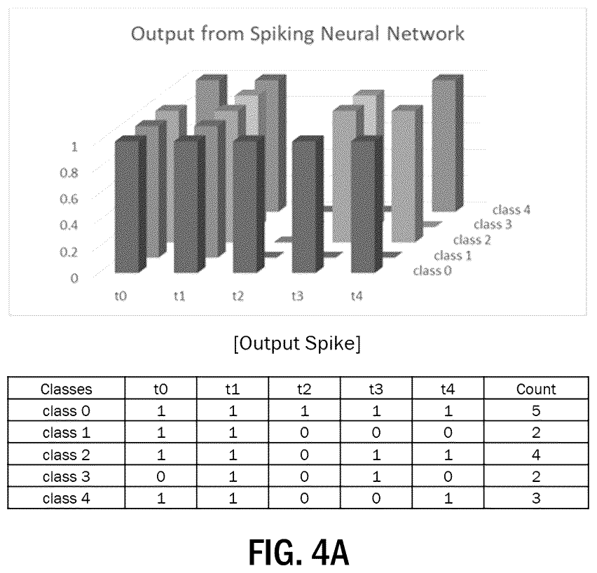

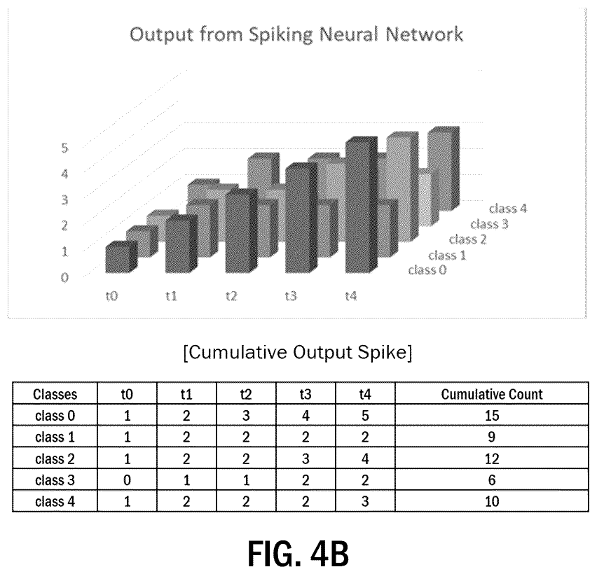

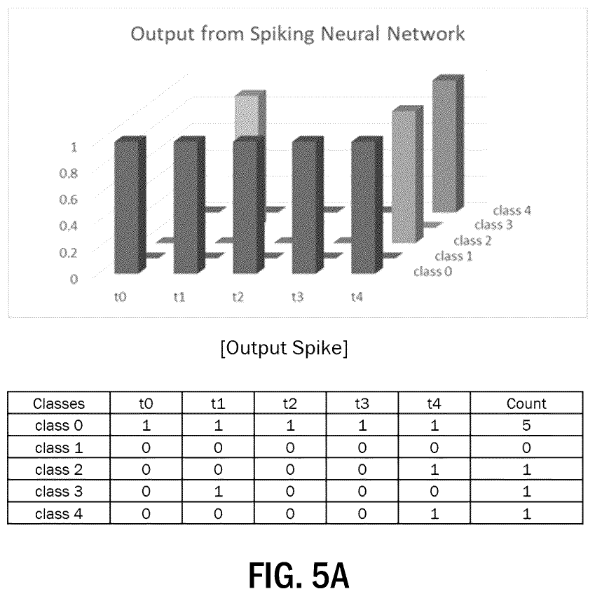

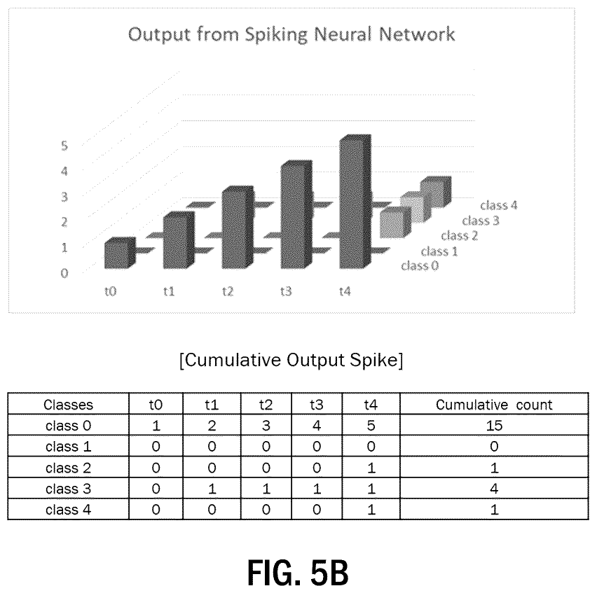

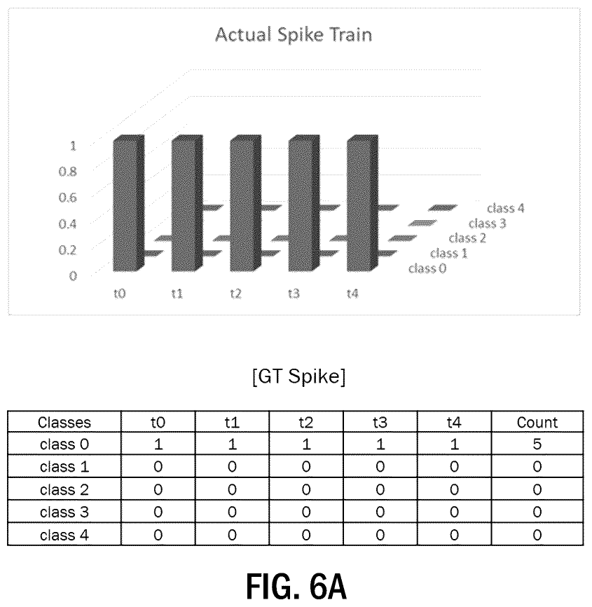

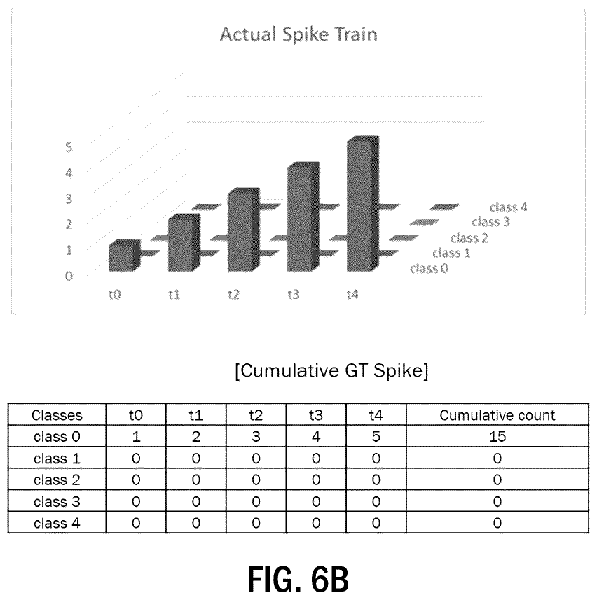

FIG. 4A shows the final output spike values d[t] presented in FIG. 1, and FIG. 4B shows the final output spike cumulative values D_{c}[t] therefor. FIG. 5A shows the final output spike values d[t] presented in FIG. 2, and FIG. 5B shows the final output spike cumulative values D_{c}[t] therefor. FIG. 6A shows the correct answer spike values s[t] presented in FIG. 3, and FIG. 6B shows the correct answer spike cumulative values S_{c}[t] therefor.

According to Equation 2 above, the loss (L) is the sum of squared values of the difference between the final output spike cumulative value D_{c}[t] and the correct answer spike cumulative value S_{c}[t] of each class from t₀ to tₖ.

As described above, the loss function used in embodiments of the disclosure may calculate a squared value of the difference between time-series output cumulative data D_{c}[t], which results from time-series accumulation of time-series output data d[t], and time-series cumulative correct answer data S_{c}[t], which results from time-series accumulation of time-series correct answer data s[t], within a defined time section for all classes, and may calculate the sum of the squared values as a loss.

Since the SNN outputs the final output spike values d[t] continuously in a time-series manner, not only classification but also loss calculation above may be performed by dividing the final output spike values d[t] in the unit of a defined time section (5 stages (t₀ to tₖ) in the above example). In addition, the SNN may classify data by class and may output a plurality of pieces of time-series output data simultaneously. Accordingly, when a loss is calculated, the sum of squared values of the difference calculated in the defined time section for all classes is required.

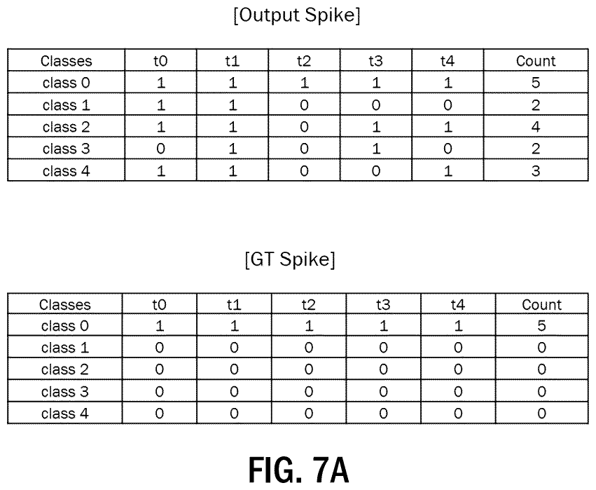

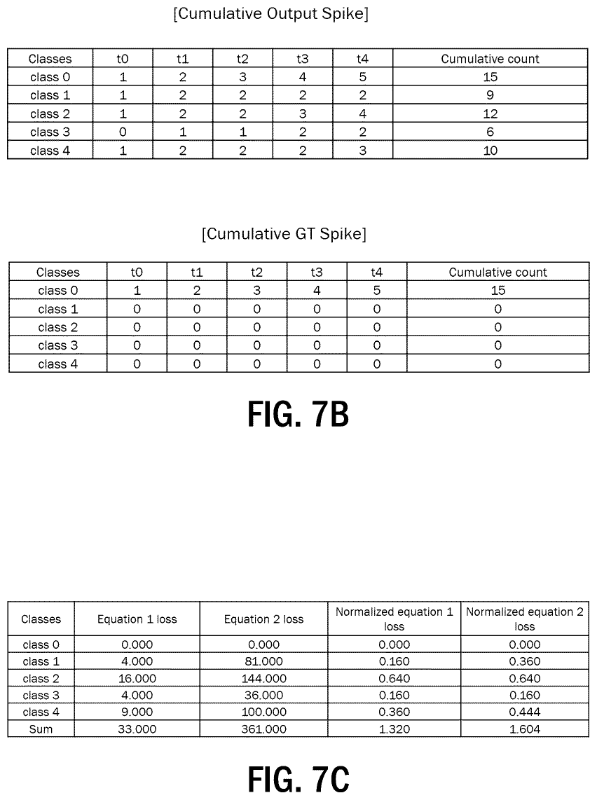

FIGS. 7A-7C show results of calculating the loss according to Equations 1 and 2 for the example of FIGS. 4A and 4B. In the example of FIGS. 4A and 4B, the difference between the output spike count values [5, 2, 4, 2, 3] of each class is not great so that classification is difficult for the SNN. Since all values increase in both the case of counting the final output spike values (FIG. 7A) and the case of accumulating the final output spike values (FIG. 7B), losses may be normalized with reference to a maximum count value and a minimum cumulative value when the losses are calculated, in order to offset the increase in the data size caused by counting and accumulation (FIG. 7C).

In the case of Equation 1, the normalized loss was calculated as 1.320, and in the case of Equation 2, the normalized loss was calculated as 1.604. That is, the loss by Equation 2 is greater, which is desirable for the training of the SNN. This is because the loss is larger for data that is difficult to classify and the parameters of the SNN are updated more during the backpropagation process.

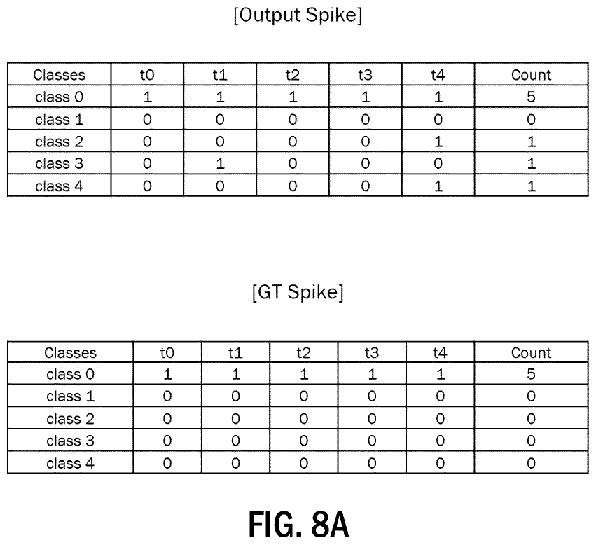

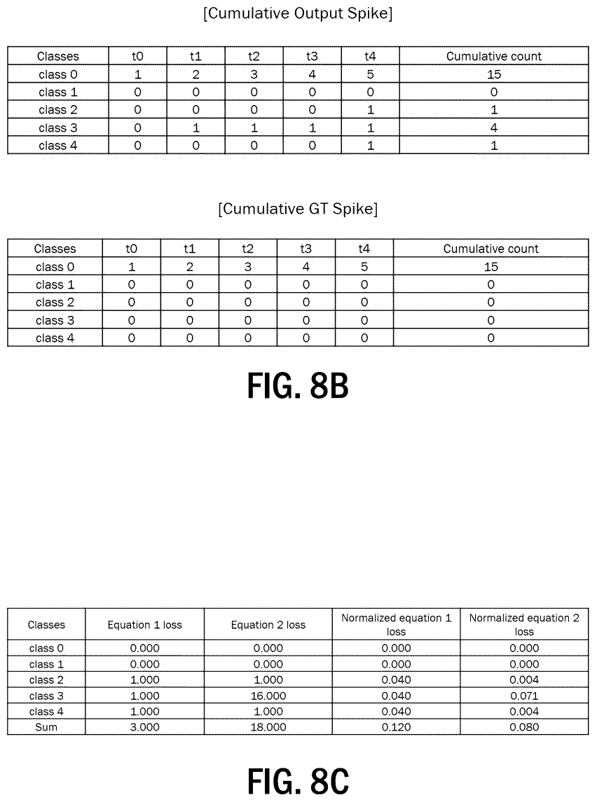

FIGS. 8A-8C show results of calculating the loss according to Equations 1 and 2 for the example of FIGS. 5A and 5B. In the example of FIGS. 5A and 5B, the difference between the output spike count values [5, 0, 1, 1, 1] of each class is great so that classification is easy for the SNN. In the present example, the losses that are normalized (FIG. 8C) with reference to a maximum count value (FIG. 8A) and a minimum cumulative value (FIG. 8B) when the losses are calculated are also presented.

In the case of Equation 1, the normalized loss was calculated as 0.120, and in the case of Equation 2, the normalized loss was calculated as 0.080. That is, the loss by Equation 2 is smaller, which is desirable for the training of the SNN. This is because the loss is smaller for data that is easy to classify and the parameters of the SNN are updated less during the backpropagation process.

As described above, the loss function by Equation 2 may more reinforce the positive correlation between the loss and the class classification difficulty. This is because, as the class classification difficulty increases, the loss increases.

In addition, the loss function by Equation 2 may more reinforce the positive correlation between the loss and the similarity between output spike count values of each class. This is because, as the similarity between output spike count values of each class increases, the loss increases.

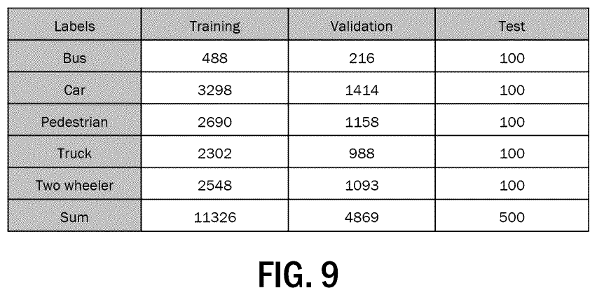

To verify the performance of SNN training using the loss function according to Equation 2, Gen4 [Automotive Detection dataset Learning to Detect Objects with a 1 Megapixel Event Camera, Prophesee, 2020] of Prophesee was processed, and TSSL-BP which is a SNN was trained by using label imbalance training data (with much less Bus data, FIG. 9) that was made for classification and had 5 classes, and it was verified how well the label imbalance training data was trained with a dataset for verification and a dataset for testing. All parameters including random seeds were made to be the same during training and only the loss function was differentiated between Equation 1 and Equation 2.

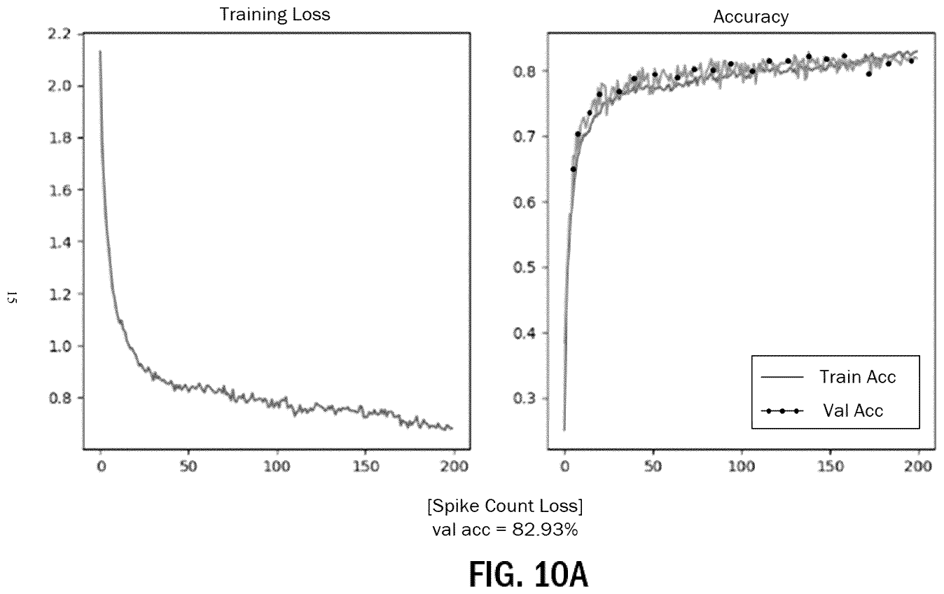

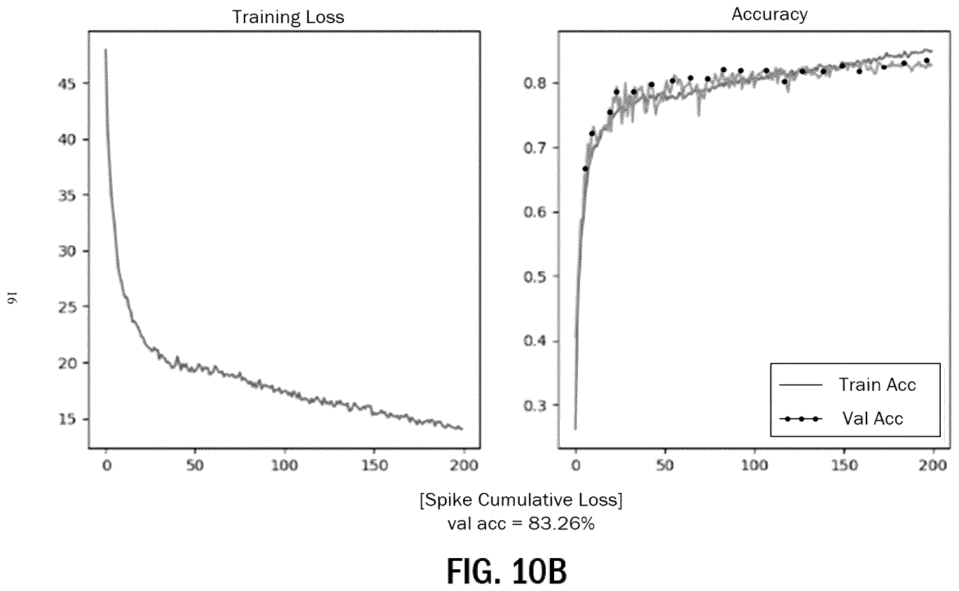

FIG. 10A shows results of training by Equation 1 (spike count loss), and FIG. 10B shows results of training by Equation 2 (spike cumulative loss), and it is identified that accuracy in the case of Equation 2 is higher.

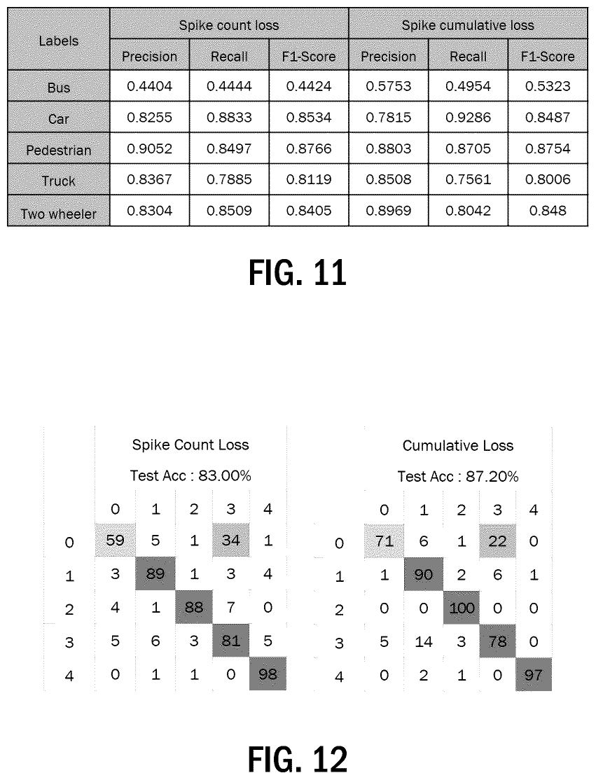

FIG. 11 is a table showing results of comparing precision, recall, F1-score for each class of verification data by Equation 1 and Equation 2. It is identified that training is uniformly performed at all levels when the loss function by Equation 2 presented in the embodiment of the disclosure is used. In particular, in the case of Bus with a very small number of pieces of data, F1-score is enhanced by nearly 10%.

Meanwhile, as a result of checking the performance based on a balanced test dataset with 100 datasets for each class, the test accuracy is improved by 4.2% from 83% to 87.2% as shown in FIG. 12, and the accuracy of classification of Bus class with severe data imbalance is particularly improved.

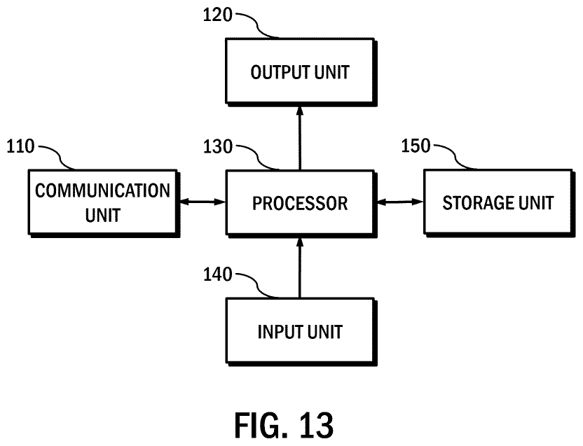

FIG. 13 is a view illustrating a configuration of an SNN operating system according to an embodiment of the disclosure. As shown in FIG. 13, the SNN operating system according to an embodiment may be implemented by a computing system including a communication unit 110, an output unit 120, a processor 130, an input unit 140, and a storage unit 150.

The communication unit 110 is a communication interface for connecting with an external network or an external device, the output unit 120 is an output means for displaying a result of calculating by the processor 130, and the input unit 140 is a user interface for receiving a user command and delivering the same to the processor 130.

The processor 130 may train an SNN and may classify classes of input data by using the trained SNN. Specifically, the processor 130 may input time-series event-based training data to the SNN, may calculate a loss between a correct answer spike cumulative value, which results from accumulation of time-series correct answer data, and a final output spike cumulative value, which results from accumulation of time-series output data outputted from the SNN, and may update parameters of the SNN based on the calculated loss.

When training is completed, the processor 130 may acquire time-series event-based training data, input the same to the SNN, and classify classes based on final output spike values which are time-series output data outputted from the SNN.

The storage unit 140 may provide a storage space needed for functions and operations of the processor 130.

Up to now, the AI model training method using the accumulative loss function has been described in detail with reference to the preferred embodiments.

In the above embodiments, by training an SNN using an accumulative loss function which is a customized loss function considering characteristics of event-based data generated by an event camera, the problems of temporal continuity, sparsity, imbalance of the event data may be solved.

The SNN and the event-based data mentioned in the above-described embodiments have been mentioned as examples of the AI model and the time-series data. That is, for AI models other than the SNN and time-series data other than event-based data, such as medical bio-signal sensor data like electrocardiography (ECG) sensor data and photoplethysmography (PPG) sensor data, vibration sensor data, and temperature sensor data, training based on Equation 2 above is possible, and this case may belong to the scope of the disclosure.

Furthermore, class classification is merely mentioned as one of the inferences enabled by the AI model. For AI models performing other inferences than class classification, such as event-based object detection and predicting, generating, and concerting, transforming, training based on Equation 2 above is also possible.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. An AI model training method comprising:
inputting time-series training data into an AI model;
calculating a loss between time-series correct answer data and time-series output data which is outputted from the AI model; and
updating parameters of the AI model based on the calculated loss,
wherein calculating comprises calculating, as the loss, a difference between time-series output cumulative data, which results from time-series accumulation of time-series output data, and time-series cumulative correct answer data, which results from time-series accumulation of time-series correct answer data.

2. The AI model training method of claim 1, wherein the AI model outputs a plurality of pieces of time-series output data simultaneously,
wherein the correct answer data is a plurality of pieces of time-series correct answer data, and
wherein calculating comprises calculating, as the loss, a sum of each difference between each piece of time-series output cumulative data, which results from the time-series accumulation of each piece of time-series output data, and each piece of time-series cumulative correct answer data, which results from the time-series accumulation of each piece of time-series correct answer data.

3. The AI model training method of claim 2, wherein the plurality of pieces of time-series output data and the plurality of pieces of time-series correct answer data are data corresponding to a plurality of classes.

4. The AI model training method of claim 3, wherein the loss has a positive correlation with a class classification difficulty.

5. The AI model training method of claim 3, wherein the loss has a positive correlation with a similarity between the plurality of pieces of time-series output data.

6. The AI model training method of claim 1, wherein the loss is normalized to offset an increase in a data size caused by data accumulation.

7. The AI model training method of claim 1, wherein calculating comprises dividing the time-series output data in the unit of a defined time section and accumulating the time-series output data.

8. The AI model training method of claim 1, wherein the time-series training data and the time-series correct answer data are event camera data.

9. The AI model training method of claim 1, wherein the AI model is a spiking neural network (SNN) for data classification.

10. An AI model training system comprising:
a processor configured to input time-series training data into an AI model, to calculate a loss between time-series correct answer data and time-series output data which is outputted from the AI model, and to update parameters of the AI model based on the calculated loss; and
a storage unit configured to provide a storage space needed for the processor,
wherein the processor is configured to calculate, as the loss, a difference between time-series output cumulative data, which results from time-series accumulation of time-series output data, and time-series cumulative correct answer data, which results from time-series accumulation of time-series correct answer data.

11. An AI model inference method comprising:
acquiring time-series data; and
inputting the acquired time-series data into an AI model and performing inference,
wherein the AI model is trained to generate a result of inference from time-series input data as time-series output data, and is trained by calculating, as a loss, a difference between time-series output cumulative data, which results from time-series accumulation of time-series output data, and time-series cumulative correct answer data, which results from time-series accumulation of time-series correct answer data.
